(19) United States
(12) Patent Application Publication
(10) Pub. No.: US 2017/0374516 A1
(43) Pub. Date: Dec. 28, 2017

(54) TECHNIQUES FOR OPERATING A DISTRIBUTED COMMUNICATION NETWORK

(71) Applicant: ZTE Corporation, Shenzhen (CN)

(72) Inventor: David Di Huo, Newton, NJ (US)

(73) Assignee: ZTE Corporation, Shenzhen (CN)

(21) Appl. No.: 15/536,106

(22) PCT Filed: Dec. 14, 2015
(86) PCT No.: PCT/US2015/065644

§ 371 Date: Jun. 14, 2017

Related U.S. Application Data
(60) Provisional application No. 62/091,611, filed on Dec. 14, 2014.

(51) Int. Cl. H04W 4/02; H04W 4/00; H04L 29/08; H04W 84/18; H04L 12/28

(52) U.S. Cl. CPC H04W 4/023; H04W 84/18; H04L 12/28; H04L 29/08; H04W 4/006

(57) ABSTRACT

A distributed network of communication nodes is organized in a hierarchy of clusters. Upon deployment, nodes exchange messages to form an upper layer cluster and multiple lower layer clusters. Each lower layer cluster may be in communication with one upper layer cluster node, which may function to communicate messages to/from the nodes in the lower layer cluster to the upper layer nodes. Cluster formations may be achieved by exchanging messages among member nodes. The communication between nodes during the operation of the distributed network is based on a consensus protocol such as a modified Paxos protocol, as described herein.

### CROSS REFERENCE TO RELATED APPLICATIONS

This patent document claims the benefit of priority of U.S. Provisional Patent Application No. 62/091,611, filed on Dec. 14, 2014. The entire content of the before-mentioned patent application is incorporated by reference as part of the disclosure of this document.

### BACKGROUND

Many applications today require physical measurement by a large number of sensors or coordinated operations by a large number of robots. Examples of such applications include disaster release in dangerous locations, environment surveillance in large remote areas, medical supervision over distances and many others. The communication network those applications could be distributed over a large geographical area or of a large number of nodes or both.

### SUMMARY

Methods and systems for hierarchical sensor network are presented in the current disclosure. The hierarchical network architecture can be used to organize large sensor or robot networks over large areas, while maintaining low power consumption and distributed control.

In one example aspect, a sensor network is disclosed. The system includes a proposer node that is a sensor node capable of gathering and processing sensory information and communicating with other nodes in the network. The system includes a set of proxy acceptor nodes that are sensor nodes. Each proxy acceptor node and the proposer node are communicatively connected by a first topology. The system includes a set of cluster proposer nodes that are sensor nodes. A proxy acceptor is connected to, or is also, an associated cluster proposer, each cluster proposer has its set of cluster acceptors and each cluster proposer and its set of cluster acceptors are connected by an individual topology.

In another example aspect, a method performed by a sensor node is disclosed. The method includes activating a sensor node in a sensor network, sending a message to other connected sensor nodes indicating a power level of the sensor node, receiving messages from other connected sensor nodes indicating power levels of other connected sensor nodes, and determining the sensor node to function as a proposer to form a cluster, initiate a consensus protocol, and reach a consensus, or as an acceptor to be a part of a cluster waiting for a consensus forming protocol message from a proposer.

In yet another example aspect, a communication network is disclosed. The network includes an upper layer cluster of a plurality of member communication nodes and a plurality of lower layer clusters, each comprising one or more member nodes. Each node in the upper layer cluster is communicatively coupled with a node in a different one of the plurality of lower layer clusters. Each cluster is formed based upon a voting performed by its member nodes. A cluster is a logical group of nodes that communicate application layer data with other member nodes of the same cluster.

In another example aspect, a method of operating a communication node in a distributed network of multiple communication nodes in which communication nodes are logically organized in an upper layer cluster and a plurality of lower layer clusters such that one node from each of the lower layer cluster is communicatively coupled to a different node from the upper layer cluster is disclosed. The method includes communicating with a first set of communication nodes to form the upper layer cluster, communicating with a lower layer communication node that is not in the first set of nodes to establish a communication coupling to a lower layer cluster of which the lower layer communication node is a member, and facilitating message communication between the upper layer cluster and the lower layer cluster.

These, and other features, are further described in the present document and Appendix A, which forms a part of the present description.

### BRIEF DESCRIPTION OF THE DRAWINGS

FIG. 1 shows example hierarchical network architecture for a sensor network, with an up layer cluster and a plurality of low layer clusters.

FIGS. 2A-2B show an exemplary sensor network forming a hierarchical network architecture for the sensor network.

FIGS. 3-7 show examples how Paxos consensus protocol works in a flat distributed network. Among them, FIG. 3 shows actors of an exemplary Paxos consensus protocol in a distributed network, FIG. 4 shows exemplary steps performed in the two phrases of the Paxos protocol, FIG. 5 shows the application of Paxos protocol in the sensor network, FIG. 6 shows an exemplary states model for Paxos protocol, and FIG. 7 shows an exemplary protocol sequence of Paxos protocol.

FIG. 8 shows an exemplary probability of forming a majority in an n-node sensor network.

FIGS. 9A-9B show an exemplary sensor network forming a hierarchical network architecture for the sensor network, where the modified Paxos consensus protocol is applied.

FIGS. 10-11 show how the modified Paxos consensus protocol works in a hierarchical sensor network. Among them, FIG. 10 shows an exemplary sequence operations of a modified Paxos consensus protocol in a hierarchical network, FIG. 11 shows conditions in the layered hierarchical network

FIG. 12 shows an example method of forming a hierarchical network.

FIG. 13 shows an example method of operating an upper layer communication node in a distributed network.

FIG. 14 shows an example method of operating a lower layer communication node in a distributed network.

Like reference symbols indicate like elements throughout the specification and drawings.

### DETAILED DESCRIPTION

In applications such as sensor networks or other applications where a large number of communication nodes are deployed, it may be desirable to be able to deploy nodes and sustain ongoing operation without having to actively manage network operations such as node power management and group management. A network of sensors is one such example. Communication nodes in such a network may perform both communication operations, e.g., signal transmissions and/or reception and also perform a sensing operation in which the node senses a physical attribute such as temperature, humidity, air pressure, radio activity, light intensity, and so on. For such sensor networks, each network node should be capable of autonomous actions, such as gathering and processing sensory information and communicating with other nodes in the network. The network nodes require simple node equipment, low power consumption, yet simple in maintenance, easy in deployment with flexible topology, and without stringent latency budget.

Many Internet of Things (IoT) applications in the future will require sensor measurement or robotic operation in a large autonomous network with up to hundreds or even millions nodes. For instance, in disaster release in dangerous locations, environment surveillance of inaccessible area, remote medical supervision, just to quote a few. Such applications require a communications network of large number of nodes over extended geographical area. The network shall be able to operate autonomously and maintain consistence in actions across nodes. Given the nature and circumstance of the deployment, the hardware as well as software are expected to be identical on all nodes, so that operation without maintenance is possible at a low cost. Such a network is referred to as large sensor network (LSN) and its deployment often involves unknown random node locations and it is designed for latency tolerant services. To meet those requirements, a distributed network protocol is necessary, because in a distributed network every node is equivalent to every other node and there is no permanent centralized control functions built in. In specifics, a distributed network, seen from outside as an entity, is autonomous. Such network is robust against node fault and is self-adaptive to the change of network topology. Fault tolerance of the distributed network is achieved by means of distributed networking based on identical node design. The self-adaptivity is enabled by the underlying consensus protocol. Distributed networking has the potential to avoid complex transceiver hardware and system control software and, as such, can reduce power consumption and operation maintenance and, eventually, the total system cost.

Network architectures describe the way to organize a number of network nodes, while communication technologies provide the communication means among network nodes. Current network architectures and communication technologies can include, for instance, Wi-Fi alias IEEE802.11g, Bluetooth alias IEEE802.15.1, ZigBee alias IEEE802.15.4, or IEEE802.11ad for millimeter wave and many others. All these technologies are designed for short range communication, on top of which application specific network protocols can be implemented. It is often the case that the standard technologies may contain functions that are not needed for a given application while missing functions that are specific to the application.

Current research in sensor network focuses mostly on lower OSI layers and small networks, where a master-slave relation between nodes is all that are needed to set up a network. This principle of networking applies to wireless network on licensed frequency band, e.g. 3GPP and 3GPP2, as well as on ad-hoc network on unlicensed frequency band, e.g. IEEE 802. For LSN, these technologies encounter scalability issues, because those technologies rely on centralized networking, in which there are distinguished nodes serving as the master, or base station, and those nodes are known before the network setup. In LSN application, however, node locations are unknown prior to the deployment and the network is set up autonomously even when almost half the nodes fail. To make this possible, hardware and software in a distributed network will have to have identical capability, so that every node can replace any other node to provide required service. Therefore, while the current technologies show quite acceptable performance in small networks, no concept is available today for distributed operation expected by LSN. Moreover, these current technologies cause issues in energy consumption as well as in operation reliability for large sensor networks used in applications such as disaster release in dangerous locations, environment surveillance in large remote areas, medical supervision over distances and many others.

In search of a network protocol that can meet the operation requirement of LSN, the recent successful deployment of Paxos in the large scale data center network by Google and Amazon is worth mentioning. Paxos allows all nodes in the network to share the same information and every one can replace any other node in its function. Being proposed 30 years ago, Paxos has been studied for more than 20 years, but mostly in terms of feasibility as applied to computer networks. More discussions appear in the recent years regarding its implementation due to the increasing interest in the information industry. Performance study is, however, so far unknown yet, partly because the implementation is complex and the performance depends on the software implementation. Even in the few known deployments, the number of nodes involved is in the order of two digits, which is much less than that expected by LSN applications. What is more important in this context is the channel: the data center network is based on reliable communication channels made of high quality optical transport facilities, where the reliability exceeds six nines following decimal point after zero. Thus the protocol there is almost independent of the quality of the communication channel. Applications to large number of nodes with unreliable channels is unknown so far and hence worth a theoretical study in view of its feasibility.

The techniques described in the present document can be used to overcome these operational limitations, and others, with present day distributed network and sensor network technologies.

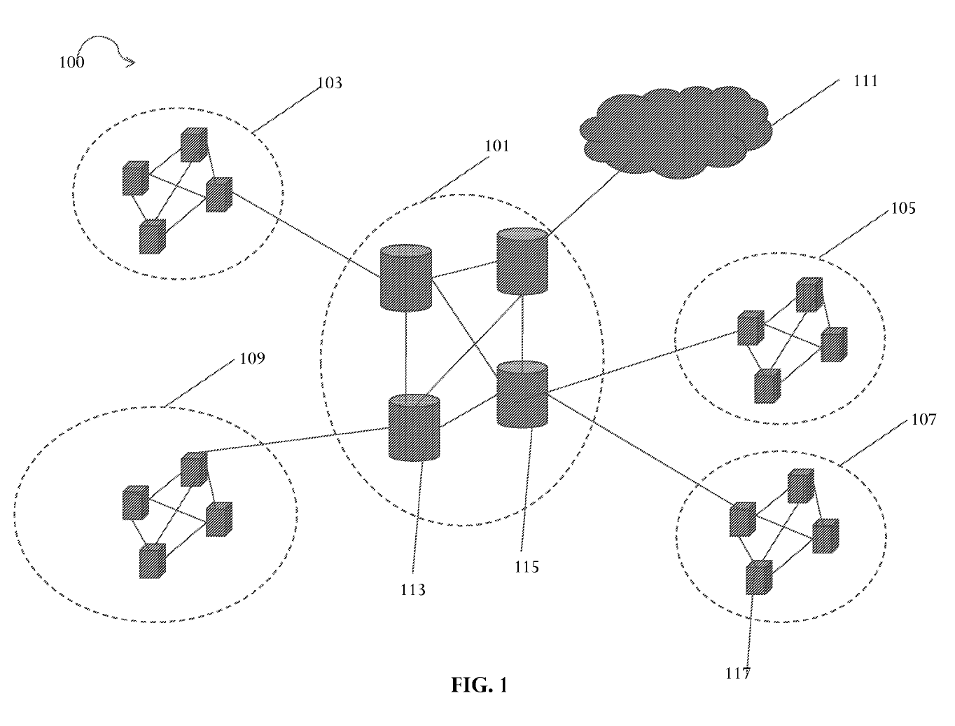

FIG. 1 shows an exemplary hierarchical network architecture for a sensor network 100, with an up layer cluster 101 and a plurality of low layer clusters 103, 105, 107, 109. The senor network 100 can further contains a cluster of sensor nodes 111 connected in the cloud. Each cluster 101, 103, 105, 107, 109 contains a plurality of sensor nodes. Each sensor node such as the sensor node 113, the sensor node 115, and the sensor node 117 should be capable of autonomous actions, simple node equipment, low power consumption, yet simple in maintenance, easy in deployment with flexible topology, and without stringent latency budget. However, different sensor nodes, such as the sensor node 113, the sensor node 115, and the sensor node 117 may have different power level at different times.

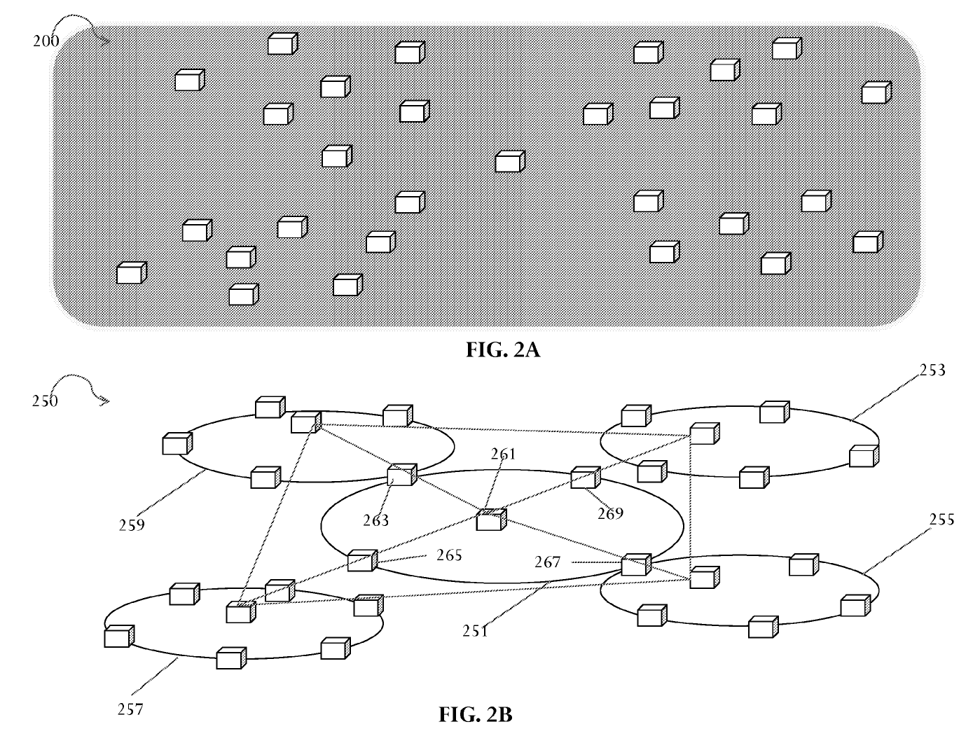

FIG. 2A shows an exemplary flat sensor network 200. The sensor network 200 contains many different sensor nodes placed at various locations. The number of sensor nodes can be around hundreds, thousands, or even millions, depending on the application. For a sensor network with a large number of sensor nodes, the communication between different senor nodes can be difficult, and a centralized architecture can be difficult to implement and maintain.

FIG. 2B shows an exemplary hierarchical network 250 formed for a sensor network, with an upper layer cluster 251 and a plurality of lower layer clusters 253, 255, 257, and 259. Each cluster 253, 255, 257, and 259 contains a plurality of sensor nodes. The upper layer cluster 251 contains 5 nodes all connected together, which are fully connected with the sensor node 261 as the center. A cluster of nodes, such as the cluster 251, are either structurally connected together or logically connected together. A node can belong to more than one cluster. For example, the node 263 belongs to the upper cluster 251, as well as the lower cluster 259. On the other hand, the node 261 belongs only to the upper layer cluster 251. The connections for the nodes in the cluster 251 are only for illustration purposes and are not limiting. Other forms of connections are possible. The nodes and the connections between the nodes collectively form a topology.

For each node in the upper layer cluster 251, it is connected to a node in a lower layer cluster. For example, the node 263 is connected to a node in the lower layer cluster 259. The node 265, node 267, and node 269 are each connected to a node in the cluster 257, cluster 255, and cluster 253, respectively. The example only shows two layers of hierarchy. More than two layers of hierarchy can be formed, depending on the number of sensor nodes and the applications.

The sensor network 250 is an example of distributed sensor network, where no central control is needed. Such a network can operate without a permanent hub, while still maintaining consistent operations, appearing as a single node to the outsider. One problem in distributed computing is to achieve overall system reliability in the presence of a number of faulty processes. This often requires processes to agree on some data value that is needed during computation. Examples of applications of consensus include whether to commit a transaction to a database, agreeing on the identity of a leader, state machine replication, and atomic broadcasts. The Paxos protocol is one protocol used to achieve consensus in a distributed network. However, for a distributed hierarchical network 250, Paxos protocol would not apply. Therefore there is a need for a new consensus protocol for the distributed hierarchical network 250.

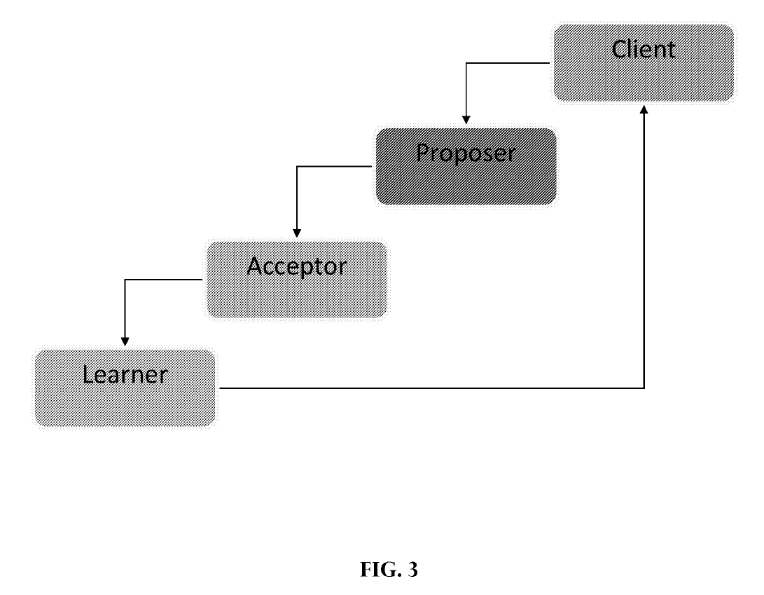

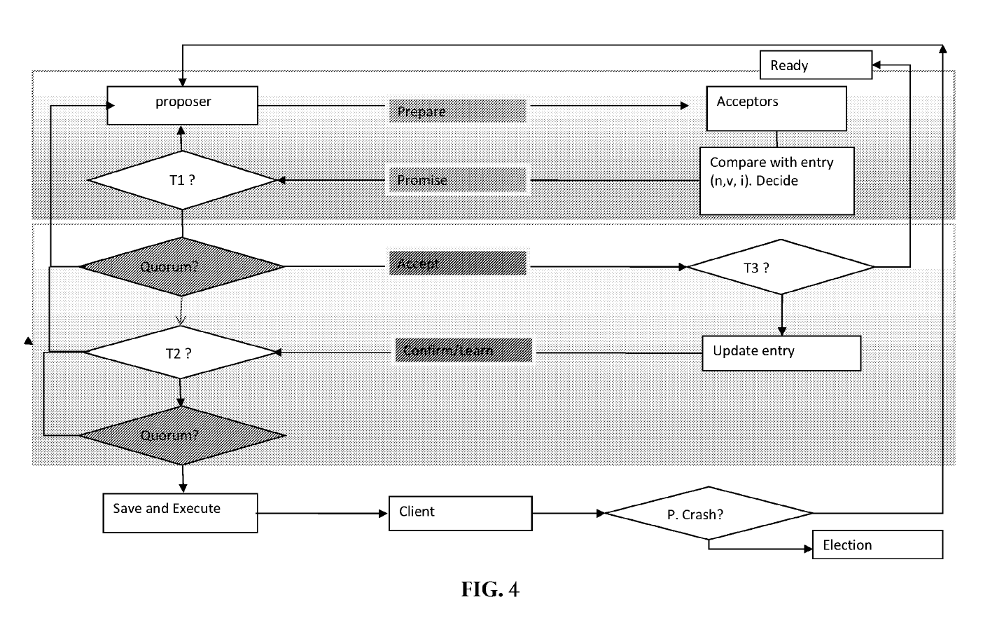

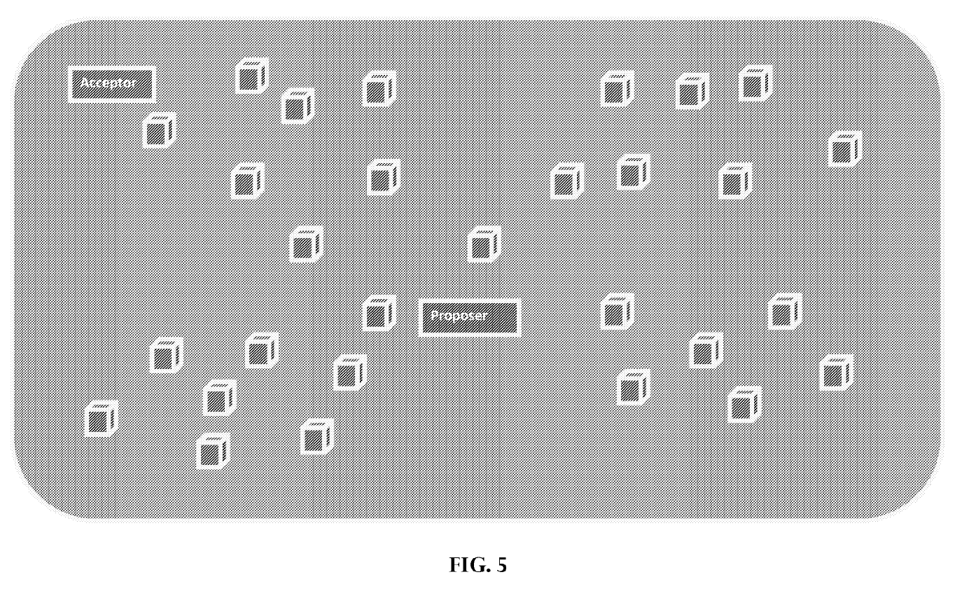

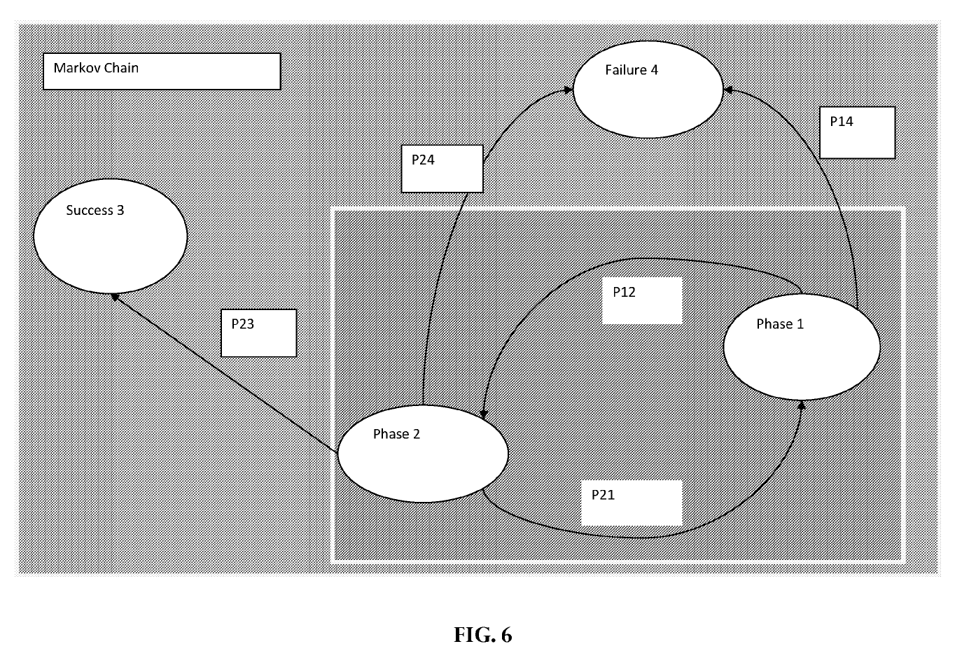

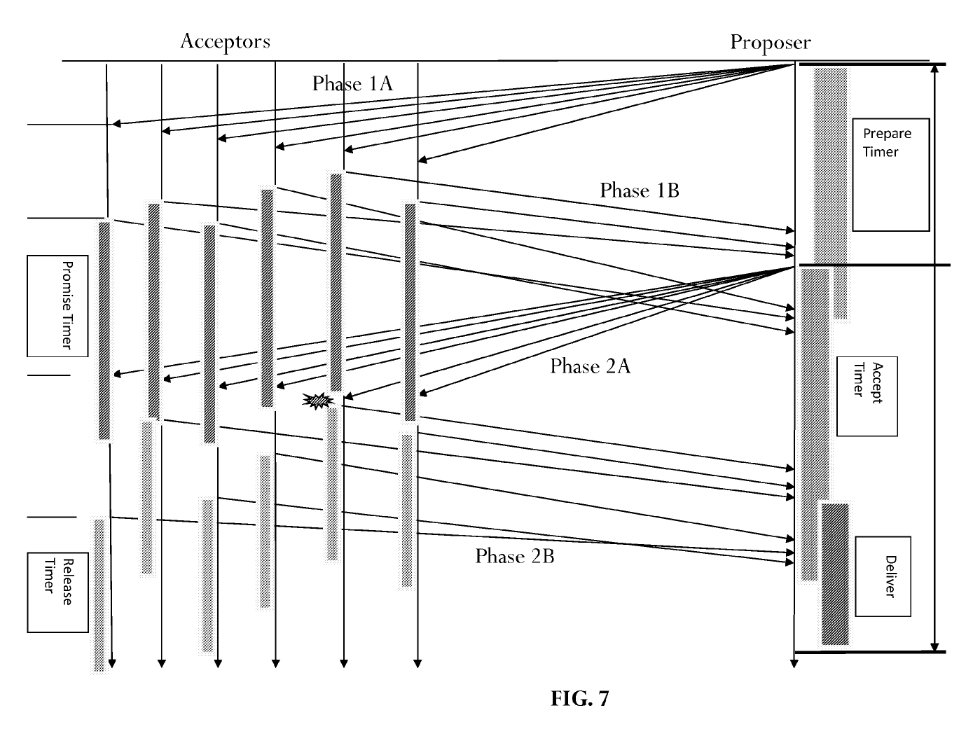

FIGS. 3-7 show how Paxos consensus protocol works in a flat distributed network. Among them, FIG. 3 shows actors of an exemplary Paxos consensus protocol in a distributed network, FIG. 4 shows exemplary steps performed in the two phrases of the Paxos protocol, FIG. 5 shows the application of Paxos protocol in the sensor network, FIG. 6 shows an exemplary states model for Paxos protocol, and FIG. 7 shows an exemplary protocol sequence of Paxos protocol.

Paxos is a protocol of achieving consensus for asynchronous distributed computers and processors. There, the central task is to populate state information, coined as “ballot value”, to all nodes in the network in a consistent manner. A consensus is achieved when all participating nodes in the network agree on the same value for a ballot. This is made possible when more than half of the nodes respond to the solicited ballot and the responses are received by the ballot initiator.

As shown in FIG. 3, in Paxos, each network node can play three roles: proposer, acceptor and learner. A proposer sends out requests and collects the responses; an acceptor confirms the reception of the requests by updating the proposer with its own status. When the proposer sees consensus among the acceptors, it sends the message to all learners and, thus, closes the instance. The interaction of these roles can be described by using the following terminologies:

1. Quorum: When responses from a majority of acceptors are received by the proposer, a quorum is present. Hence Paxos on a network with 2f+1 nodes can tolerate maximum f faulty nodes. When quorum is present for a ballot in all phases of the protocol, a consensus is said to be achieved for this ballot.
2. Election: When no quorum is present after a certain number of repeated tries, a process called election will start, triggered by timer implemented at acceptors. Election is a contention resolution process and will ends with one node emerging as the new proposer.
3. Client: The content of each ballot, i.e. its value, comes from clients that can communicate with the proposer. A client initiates Paxos instances by sending a request to the proposer, it receives the passed ballot as closure of the instance, together with other service data if applicable.
4. Fault: A node fault accounts for both the hardware defect as well as variation in communication channels. There are two types of fault: Fail-stop and Byzantine. Fail-stop fault occurs when a node fails and recovers some time later, while a Byzantine fault occurs when there is malicious action involved. This patent document considers the fail-stop fault only, leaving the Byzantine to the security architecture.

FIG. 4 shows exemplary steps performed in the two phrases of the Paxos protocol. In Phase 1, the proposer sends out Prepare message and the acceptor sends out promise message. In phrase 2, the proposer sends out Accept message when a quorum is met at proposer, while the acceptor sends out confirm message.

FIG. 5 shows the application of Paxos protocol in the sensor network, where one proposer exists, and all other nodes are acceptors and learners. For such a network architecture, the proposer has to communicate with all other nodes, making it a bottleneck of the communication, with increased delay and reduced reliability. The heavy computation and communication by the proposer can consume its power more quickly.

FIG. 6 shows an exemplary states model for Paxos protocol. The state model comprises states, phase 1, phase 2, success 3, and failure 4. The number on each arc connecting the states, such as P21, P12, P14, P23, and P24 are probabilities from one state to another. Such a state model can be used for Markov chain simulation of the sensor network operations.

FIG. 7 shows an exemplary protocol sequence of Paxos protocol. As shown in FIG. 7, one proposer has to communicate with all other acceptor nodes. Upon receiving a service request from a client, the proposer initiates a protocol instance called a ballot that goes through the following steps before a consensus can be achieved:

1. Phase 1A: A PREPARE message is sent out by the propose to all acceptors, where the message contains a ballot number.

2. Phase 1B: Upon reception of a PREPARE message, each acceptor compares the received ballot number with the highest ballot number it has accepted so far. It sends back the highest ballot number if it is bigger than the received ballot. Otherwise it keeps the ballot and sends back a promise.

3. Phase 2A: When responses are received with quorum, the proper checks whether an already accepted ballot is among the responses. When a quorum of the responding acceptors is present within a given time, the proposer delivers the ballot to all learners. Otherwise, it has to repeat the procedure by restarting Phase 1A with an updated ballot number, or Phase 2A.

4. Phase 2B: Upon receiving the complete ballot, the acceptor compares it with its own record of the highest numbered accepted, or promised, ballot. The acceptor then determines to either send a CONFIRM to the proposer, a rejection, or just skips if it has already promised a ballot of the same or larger number. If no ACCEPT message is received before the expiration of a specified waiting time, the acceptor can start an election to bring about a new proposer.

The consensus protocol applied to distributed computer network is designed to cope with node fault that is caused by the processors, while a distributed LSN encounters node fault that is caused by both processors and communication channels. Given that radio channel is subject to variation in much greater magnitude than the aptitude of the processors which are normally characterized by given mean time to fault, the application of consensus protocol to wireless channels faces not only an additional fault source, but a complete new challenge due to complexity of the rather fast time varying unreliable channels. When the two fault sources are observed together, the channel weighs over the processor, so that the variation of channel is the primary concern in LSN. Hence, channel quality is the main focus when talking about node fault. According to the discussion among the software developers, Paxos is notorious for difficult to implement. This discourages network performance study by means of simulation using implemented protocol, and justifies a study based on analytical means. Applied to LSN, Paxos suffers under scalability problem in at least three aspects:

1. Capacity: In order for every node in LSN to have identical capability, it is necessary that the received power density is the same regardless where the transmitting node is. By AWGN assumption for multiple access channel, the maximum data rate for m users is upper bounded by:

$${\sum }_{i = 1}^{m} {r}_{i} < C ( mW / N ) \qquad ( 1 )$$

where rᵢ is the data rate of the ith node, C(x)=0.5 ln(1+x) the Shannon capacity function for AWGN channel, W the received signal power density and Nthe noise power density. Since the nodes are identical in capability of providing the same service, rᵢ=r for i=0, 1, . . . m. Thus

$$r < \frac{1}{m} C ( mW \text{/} N ) \qquad ( 2 )$$

As the node density of a LSN is finite, large m implies large distance between some nodes within the LSN. The above inequality implies, however, that the required received power will increase faster than m when m→∞, in order to maintain the same communication capacity. Thus, the capability of a distributed LSN is power limited. For time orthogonal usage of channel this limitation translates into a latency lower bound that is proportional to the number of nodes. By code division orthogonal channels, this limitation expresses itself in prohibitive near-far-effect.

2. Complexity: Another limitation is posed by the applicable frequency spectrum, due to technology or regulation, which makes it impossible to resolve the capacity issue by means of increasing frequency band. More effective algorithms, such as advanced channel code, interference cancellation, multi-in-multi-out technique or phased array antenna, can help only partly. Moreover, they are limited by the low cost requirement of LSN, because advanced algorithms and efficient transceivers will also increase the complexity and the cost, in addition to power consumption.

3. Power Consumption: In order to meet the requirement that every node can communicate with every other, the design shall assure sufficient transmit power for radio connection between any two nodes within an LSN. The model for the attenuation of the signal power is well known in the wireless technology (Steele ed., 1992). In this respect, the channel in LSN can only be worse, because nodes can be separated by objects that scatter and absorb electromagnetic energy differently than that of current wireless network. For a generic study,

$${w}_{r} ( r ) = \frac{{W}_{t}}{{r}^{β}} + {v}_{r} \qquad ( 3 )$$

where Wt is the transmit power, r the distance between transmitter and receiver with attenuation exponential β≧2 and vᵣ a random variable accounting for the variation of the propagation environment. Then, ideally, the expected transmit power should be adapted to the distance by

wₜ(r)=Wᵣr^{β}+vₜ (4)

with a random variable vₜ of zero mean, which accounts for the variation of the hardware limitations, and Wr the expected minimum received power. For LSN, it is however recommended that the capability of power adjustment by the transmitter be limited to a minimum, due to complexity and cost concern. Therefore, Equation (4) serves only as a reference for the power levels to be used. Since E{wₜ}=Wrr^{β} depends on the transmitter amplifier, where E refers to statistic expectation, it is upper limited a maximum imposed by the hardware, say E{wₜ}<Wmax. Thus, the maximum spatial dimension of the LSN is bounded by

D<(Wₘₐₓ/Wᵣ)^{1/β} (5)

In addition, the low cost requirement will further shrink the size of D. This turns out to be the major constraint for applying Paxos to LSN.

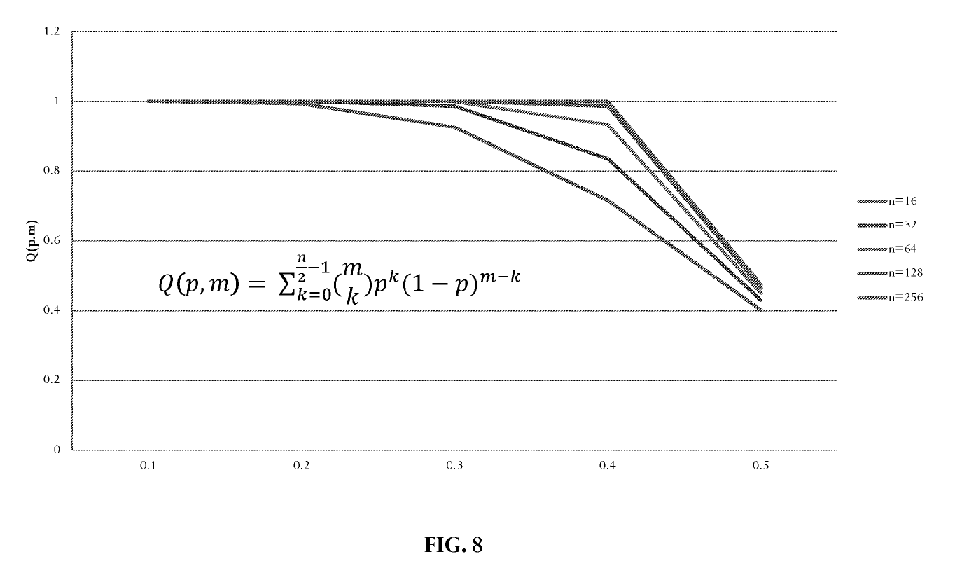

FIG. 8 shows an example of a relationship between the probability of forming a majority in an m-node sensor network for various values of the number of nodes m, where p is the probability of the fault event.

The channel impact on the Paxos performance plays out through the quorums. A node is characterized by its state, which can be measured per round, where a round is the round trip time between the acceptor and the proposer. Hence a round can also refer to the event that a message is sent by the proposer and acknowledged, or unacknowledged, by the acceptor. The outcome of this event is the node state, and it has two values: Fault or Not Fault. An independent identical distribution (IID) of state is assumed for all nodes. By this assumption, a study is based on the probability space (Ω, [symbol] ,P) where Ω is the fault event set, [symbol] is the associated algebra on Ω and P: Ω [symbol] [0,1]⊂ [symbol] the probability measure. Then, p=P(A)∈[0,1] is the probability of the fault event A⊂Ω, and the event that exactly k nodes are faulty flows the binomial distribution

$$( \begin{matrix}m \\ k\end{matrix} ) {{p}^{k} ( 1 - p )}^{m - k} \qquad ( 6 )$$

where

$$( \begin{matrix}m \\ k\end{matrix} ) = m ! \text{/} ( m - k ) ! k ! .$$

A quorum occurs when more than m/2 acceptors have responded and the responses are received. Therefore, its probability is

$$Q ( p , m ) = {\sum }_{k = 0}^{m / 2 - 1} ( \begin{matrix}m \\ k\end{matrix} ) {{p}^{k} ( 1 - p )}^{m - k} \qquad ( 7 )$$

for m mutual independent nodes, i.e. the probability that less than m/2 nodes are faulting. The mapping

Q:[0,1]× [symbol] ₘ₊₁ [symbol] [0,1] (8)

with Q(0,m)=1 and Q(1,m)=0 is shown in FIG. 8, where it is observed that Q(p, m) decreases with p and increases with m. For large m, the quorum probability remains close to unit for small p. It reaches a value around 0.5 for p regardless of n, emphasizing the dramatic dependence on channel quality. The scalability issue poses difficulty in maintaining equal channel quality for all nodes at a low cost.

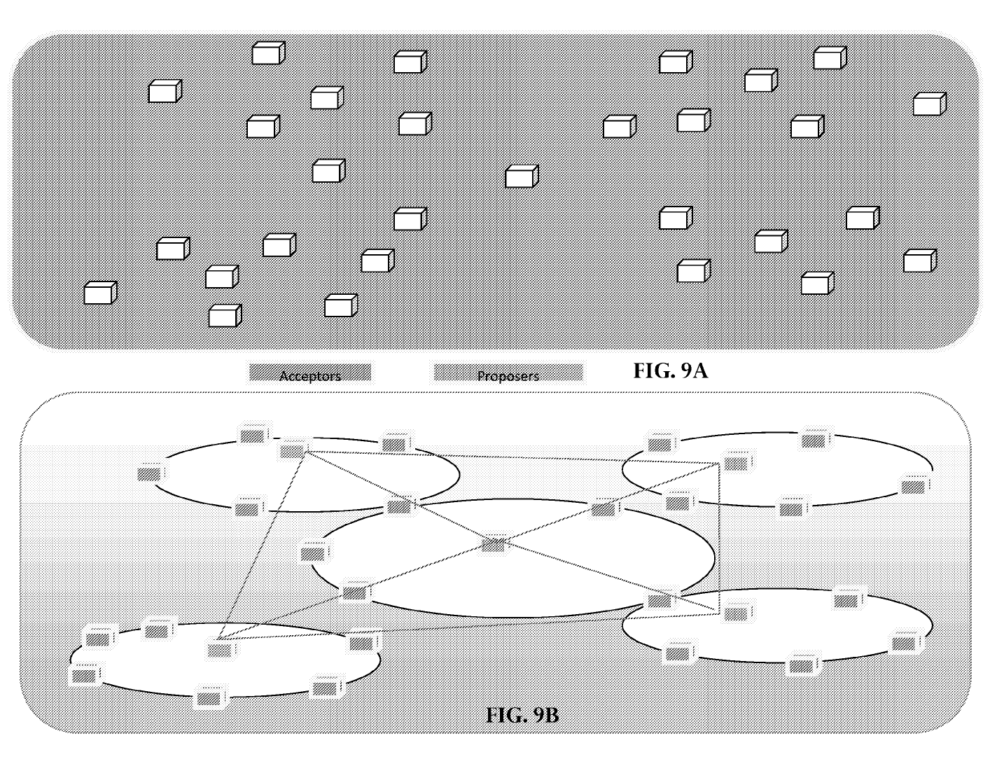

FIGS. 9A and 9B show an exemplary sensor network forming a hierarchical network architecture for the sensor network, where the modified Paxos consensus protocol is applied. As shown in FIG. 9A, the plurality of sensor nodes form a flat sensor network, which is the same as shown in FIG. 2A. However, FIG. 9B shows a hierarchical sensor network with more than one proposer. The multiple proposers can reduce the communication burden on one single proposer as shown in FIG. 5 or FIG. 7.

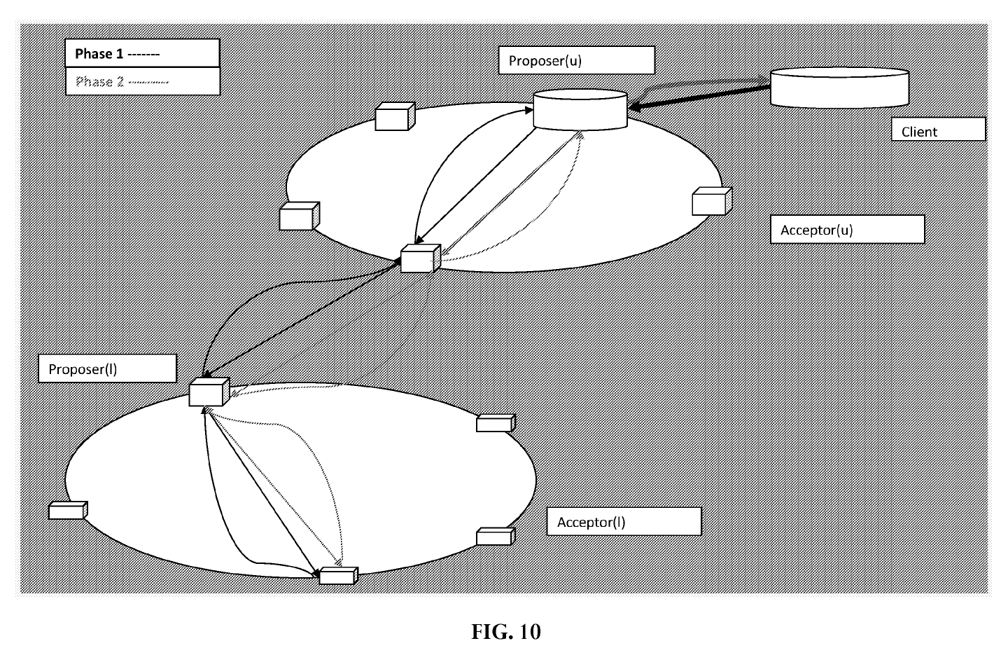

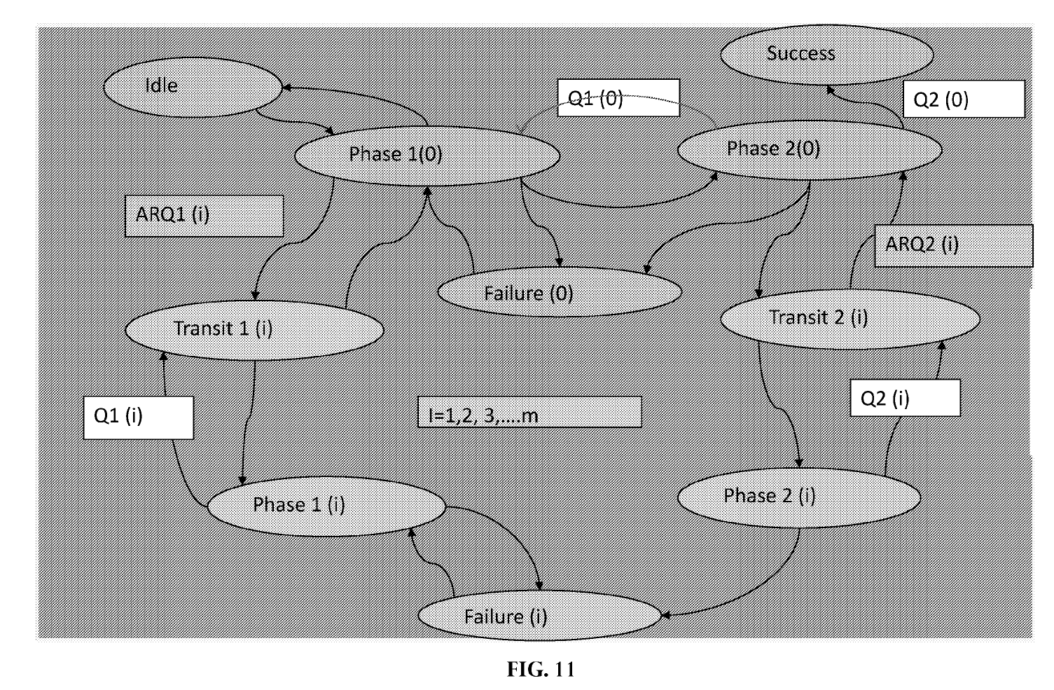

FIGS. 10-11 show how the modified Paxos consensus protocol works in a hierarchical sensor network.

FIG. 10 shows exemplary sequence operations of a modified Paxos consensus protocol in a hierarchical network. Upon receiving a service request from a client, the proposer initiates the following steps:

1. Phase 1A: Proposer u₀ of the upper layer sends out PREPARE to proxy acceptors. At the same time, it sets a timer or a counter.

2. Phase 1B: A proxy acceptor forwards the PREPARE message to the associated cluster proposer. The cluster proposer sends the PREPARE to cluster acceptors. The cluster proposer also sets a timer or a counter at the same time.

3. Phase 1C: Cluster acceptors respond to the cluster proposer with promise or rejection, and starts another timer.

4. Phase 1D: The cluster proposer, upon presence of a quorum, relays the message back to the proxy acceptor. If the timer expires without quorum, the cluster proposer repeats Phase 1B. The cluster proposer can resign as a cluster proposer after failing to reach a quorum for a pre-determined number of times.

5. Phase 1E: The proxy acceptor forwards the cluster response to the upper layer proposer u0. If the proxy acceptor does not receive the message before its timer expires, it initiates an election.

6. Phase 2A: Proposer u₀, upon presence of quorum in Phase 1, sends out an ACCEPT message with complete ballot information to all proxy acceptors. If no quorum is present, it repeats Phase 1A with updated ballot number. The proposer can resign as a proposer after failing to reach a quorum for a pre-determined number of times.

7. Phase 2B: A proxy acceptor relays the ACCEPT message to its associated cluster proposer. The cluster proposer forwards the ACCEPT message to the cluster acceptors. The cluster proposer also starts another timer.

8. Phase 2C: Cluster acceptors respond to ACCEPT with CONFIRM messages if the ballot number matches.

9. Phase 2D: The cluster proposer, upon presence of quorum, forwards the CONFIRM to proxy acceptor. When no quorum is present before expiration of the timer, the cluster proposer repeats Phase 2B. The cluster proposer can resign as a cluster proposer after failing to reach a quorum for a pre-determined number of times.

10. Phase 2E: The proxy acceptor forwards the cluster quorum to proposer u0. Proposer u₀, upon presence at upper layer, sends a DELIVER message to all learners including proxy acceptors. When no quorum is present at upper layer before the timer expires, the proposer u₀ repeats Phase 2A.

FIG. 11 shows conditions in the layered hierarchical network. It shows the states of operations in a hierarchical sensor network, such as the one shown in FIG. 9B. The hierarchical sensor network can be in the state of Phase1(0), which is the first phrase up layer communication, or at phase1(i), which is the first phrase low layer communication at a low layer cluster. Similarly, the states Phase2(0) and Phase2(i) are for the phrase 2 communications at the up layer or low layer. The states Transit1(i) and Transit2(i) are the states when the network is at the low layer cluster communication. The network further contains success state, failure state, and idle state. The numbers on the arc connecting the states are the probabilities from one state to another.

A two-layer network consists of m nodes in total, equally divided into s clusters. Each cluster is a subnetwork of m/s nodes. Then the quorum probability of a cluster (sub-network) is computed by

Qₗ(p,s,m):=Q(p,m/s) (9)

where the subscript “l” indicates the lower layer. The consensus protocol can progress if and only if there is quorum among the clusters. The consensus is measured by the upper layer quorum probability

Qᵤ(p,s,m):=Q(q,s) (10)

with cluster fault probability

q=1−Qₗ(p,s,m) (11)

where subscript “u” indicates the upper layer. This definition manifests the fact that a cluster behaves like an acceptor towards the network above it and q is seen by the upper layer as the fault probability of the proxy acceptor.

The function Qu(p,s,m) decreases with increasingp for fixed s and m, and it decreases with increasing s for fixed m and p. In order to compare the performance of one-layer with that of two-layer architectures, the difference

Q(p,m)−Qᵤ(p,s,m)=Qₗ(p,1,m)−Qᵤ(p,s,m) (12)

of the quorum probabilities of the respective architectures of the same nodes is observed. The two-layer architecture imposes no change to quorum probability for moderate to small channel fault probability p. Slight reduction of quorum probability occurs for large s and p. The chosen range for p in this example serves the sole purpose of study; the node fault probability in reality should be in the small range.

In some embodiments, a method performed by a sensor node may include activating a sensor node in a sensor network, sending a message to other connected sensor nodes indicating a power level of the sensor node, receiving messages from other connected sensor nodes indicating power levels of other connected sensor nodes, and determining the sensor node to function as a proposer to form a cluster, initiate a consensus protocol, and reach a consensus, or as an acceptor to be a part of a cluster waiting for a consensus forming protocol message from a proposer. In some embodiments, the determining operation includes comparing all the received messages from other connected sensor nodes indicating received power levels of other connected sensor nodes. For example, in some embodiments, the determination of a proposer in a network or cluster, e.g., a subnetwork, is the result of a contention resolution protocol such as Aloha, CSMA, etc. with certain adaptation. Any node can become proposer: in some cases, to break the tie, even the IP address can be used to determine the chosen node. In this sense, it is also a random result of the contention resolution protocols. Each node may maintain a list of the reception quality from all nodes, or the first few nodes, based on the reception quality. This list is determined by reception of uplink and downlink from each node and for high power and low power. The one-to-multiple relation is determined by an algorithm such as a modified stable marriage algorithm.

Each node in the distributed network may be capable of using either high power level or low power level. Depending on the association with upper-layer network or lower-layer network, a node may actually either use a high transmit power or a low transmit power mode. For example, upper-layer network typically uses high transmit power and lower layer network uses low transmit power.

Since the node location is random based on the requirement, it is assumed that it has a spatial distribution g(r,θ) where (r,θ) is the polar coordinates of the location on plane. Thus, the mean power needed for a planar LSN of area A is determined by

∫_{A}wₜ(r)g(r,θ)rdrdθ (13)

Assuming the uniform spatial distribution, which reduces g(r,θ) to a constant g⁰∈(0, 1). Further assuming the LSN consisting of a disk with diameter D, then, the mean transmit power is expected to be

$$\begin{matrix}E \{ {w}_{t} \vert D \} = \frac{{g}_{0}}{{π ( D \text{/} 2 )}^{2}} {\int }_{- π}^{π / 2} {\int }_{0}^{U cos θ} {w}_{t} ( r ) rdrd θ \\ = {w}_{0} \cdot {g}_{0} \cdot \frac{4}{π} \cdot \frac{{D}^{β}}{β + 2} 2 {I}_{β + 2}\end{matrix}$$

where the remaining integral on the right hand is

$${I}_{n} = {\int }_{0}^{π / 2} {cos}^{n} θ d θ = \frac{n - 1}{n} {I}_{n - 2} \qquad ( 14 )$$

for integer n with I₀=π2 and I₁=1. The total mean transmit power of the (single-layer) network is m·E{wᵢ|D}.

Now, since m nodes are distributed uniformly in plane and the same area is divided into s smaller equal cells, the nodes are divided into s equal sub-populations, each belonging to a smaller cell of diameter D/\sqrt{s}.The transmit power needed by a node in such a smaller cell is expected to be

$$E \{ {w}_{t} \vert D \text{/} \sqrt{s} \} = {w}_{0} \cdot {g}_{0} \cdot \frac{4}{π} \cdot \frac{{( D \text{/} \sqrt{s} )}^{β}}{β + 2} 2 {I}_{β + 2} \qquad ( 15 )$$

As result of the partition, the nodes within a cluster have a shorter mutual distance than those in different clusters. Communication in lower layer, i.e. within a cluster, requires less power that in upper layer between clusters. According to the requirement on simple node equipment, two levels of transmit power for each node is assumed: high and low. This is the minimum number of power levels that a network of two layers can have. As each cluster has m/s nodes, among which only one serves as cluster proposer, i.e. proxy acceptor, there are s proxy acceptors that use the high power level, while all the other nodes use the low power level. The total mean transmit power of the two-layer network is

(m−s)E{wₜ|D/\sqrt{s}}+sE{wₜ|D} (16)

The ratio of transmit powers of the two architectures is

$$f ( s , m , β ) := \frac{( m - s ) E \{ {w}_{t} \vert D \text{/} \sqrt{s} \} + sE \{ {w}_{t} \vert D \}}{mE \{ {w}_{t} \vert D \}} \qquad ( 17 )$$

Obviously the partition requires s being integer and even dividing m. For the time being, however, some embodiments take f(x,m,β) as a function of the continuous variable x∈[1,m], to find the second derivation

$$\frac{{\partial }^{2} f}{\partial {x}^{2}} = \frac{β}{m} {x}^{- β / 2 - 1} + ( 1 - \frac{x}{m} ) \frac{β}{2} ( \frac{β}{2} + 1 ) {x}^{- β / 2 - 2} > 0 \qquad ( 18 )$$

for x∈[1,m]. Thus, f(x,•,•) is a convex function and achieves its minimum for some x∈(0,m). Hence the boundary values are also extreme values and equation (17) is less than one for all non-trivial s∈(1,m). Therefore, it can be concluded that the expected total transmit power of a two-layer network is less than that of a one-layer network for all non-trivial partitions. Whether the reduction of transmit power leads to reduction in power consumption still depends on the channel usage and, as such, is also related to latency.

Application of large sensor network (LSN) may involve either planar network (2D) or three dimensional network (3D), hence the ratio of transmit powers of the two layers becomes in some embodiments:

$$f ( s , m , β ) = \{ \begin{matrix}( 1 - s \text{/} m ) {s}^{- β / 2} + s \text{/} m & for 2 D \\ ( 1 - s \text{/} m ) {s}^{- β / 3} + s \text{/} m & for 3 D\end{matrix} \qquad ( 19 )$$

To complete a ballot, Paxos requires two round trips at least, one for Phase-1 and one for Phase-2. Assume the MAC layer can handle multiple-access so that queuing delay can be accounted for by a constant, which can be assumed zero, as long as we are interested in latency dynamics. Then, the number k of protocol rounds is used to measure the latency. A round is thus a time unit that has the duration of a round trip. According to hierarchical Paxos, the probability of ultimate quorum for a ballot is

$${\sum }_{j = 1}^{( \begin{matrix}s \\ s / m + 1\end{matrix} )} Pr ( A , {B}_{{i}_{k}}^{( j )} , k = 1 , 2 , … , s \text{/} 2 + 1 ) \qquad ( 20 )$$

where A is the quorum event of the upper layer network and Bᵢ^{(j)} is the quorum event of cluster i∈{1,2, . . . s} of the lower layer network. The index j refers to random subset of size s/2+1 and index iₖ for k=1,2, . . . , s/2+1 indicates element of this subset. Determination of this probability and using it to compute the expected delay is not trivial, even with uniformly distributed binary channel. Some embodiments choose to give an estimate of the delay based on the assumption that upper-layer network and the lower-layer networks are independent. This assumption excludes the interaction between the two layers, hence removes the potential ping-pong effects between them in achieving the quorum. Therefore, estimate made with this assumption represents a lower bound for the accumulated latency:

$$T ( p , s , m ) := E \{ {τ}_{u} \} + {max}_{i ∈ \{ 1 , 2 , … s \}} E ( {τ}_{l} \vert i \} \qquad ( 21 )$$

where τᵤ and τₗ are the delay of upper layer and of lower layer, respectively, with i being the index of cluster. For identical distribution of node fault, the expectation of latency turns out to be a constant across all clusters, which is the maximum itself. Since geometrical distribution applied to fault probability yields the latency measured in rounds k, and each ballot requires at least two rounds to finish, a latency lower bound for the ballot can be estimated as

$${\sum }_{k = 0}^{∞} k [ {{Q}_{l}^{2} ( 1 - {Q}_{l}^{2} )}^{k - 1} + {{Q}_{u}^{2} ( 1 - {Q}_{u}^{2} )}^{k - 1} ] = {Q}_{l}^{- 2} + {Q}_{u}^{- 2}$$

where Qu and Ql are the upper layer quorum probability and the lower layer quorum probability, as defined by equation (10) and (9), respectively. Hence, when a network of m nodes is partitioned into s clusters, the expected latency lower bound is

T(p,s,m)=Qₗ⁻²(p,s,m)+Qᵤ⁻²(p,s,m) (22)

for s>1 up to a constant factor, and for s=1 we have simply T(p,1,m)=Q⁻²(p,m). It is readily seen that T(p,s,m) increases with p for fixed s and m, because both Qₗ(p,s,m) and Qᵤ(p,s,m) decrease with p. As a first approximation, the latency change can be quantified for s>1 by the difference between the minimum latencies in the two different architectures, divided by the minimum latency of the flat architecture. This is

$$\begin{matrix}h ( p , s , m ) := \frac{T ( p , s , m ) - T ( p , 1 , m )}{T ( p , 1 , m )} & ( 23 ) \\ = {[ \frac{Q ( p , m )}{{Q}_{l} ( p , s , m )} ]}^{2} + {[ \frac{Q ( p , m )}{{Q}_{u} ( p , s , m )} ]}^{2} - 1. & ( 24 )\end{matrix}$$

h(p,s,m) increases with increasing p and s, where function e^{-h(p,s,m)} is plotted and has a range of (0, 1). The mapping to exponential function helps visualization of the trends. Obviously the two-layer architecture introduces delay, because for s>1 h(p,s,m)>0, or equivalently e^{-h(p,s,m)}<1.

A priori determination of the expected cluster size using optimization would help each node to set the list length, hence facilitate the cluster forming. Design of the optimized cluster network could utilize the ratio of transmit powers as well as the latency change of the two layers.

In some embodiments, a weight parameter a can be used to bias the design preference, such that

F(p,s,m,α,β)=α·f(s,β)+(1−α)·e^{-h(p,s,m)} (25)

The design can prefer the importance of transmit power reduction or prefer the importance of protocol latency reduction. Since Equation (25) is convex with respect to s and, as such, it has minimum for some s∈[1,m], it can be used to optimize the network partition as following:

1. For given m and β, start with some a value and node quality p, based on commercial goal and technical circumstances.

2. Plot the curve F(p, s, m, α, β) as a function s, and find s=sₘᵢₙ such that F(p, sₘᵢₙ, m, α, β)<F(p, s, m, α, β) for all s∈(1,m).

3. Find 1<s<m that is the closest to and is feasible for the given network topology. The feasibility is subject to the law of spatial packing or planar tiling that applies, or any other constraint of reality.

In some embodiments, a sensor network may include a proposer, which is a sensor node capable of gathering and processing sensory information and communicating with other nodes in the sensory network, a set of proxy acceptors, which are sensor nodes, wherein each node of the set of proxy acceptors and the proposer are communicatively coupled by a first topology, a set of cluster proposers, which are sensor nodes, wherein each proxy acceptor is communicatively coupled to a corresponding cluster proposer, and a set of cluster acceptors corresponding to each cluster proposer, wherein each cluster proposer and its set of cluster acceptors are connected by an individual topology. In some embodiments the proposer and the cluster proposer and proxy acceptors have more transmit power than the cluster acceptors. In some embodiments, the first topology and the set of individual topologies demonstrate independent expected latency. In some embodiments, as described herein, the formation of the first topology and the set of individual topologies is optimized based on transmit power reduction and latency reduction. In some embodiments, a cluster acceptor is closest to its cluster proposer among any other cluster proposers and the proposer. In some embodiments, each cluster proposer has a similar number of cluster acceptors. In some embodiments, a sensor node is either pre-programmed to be a proposer at deployment, or randomly chosen to be a proposer. In some embodiments, each of the sensor nodes, e.g., the proposer, the proxy acceptor, the cluster proposer, the cluster acceptor, etc. may be implemented using a processor and a memory that stores instructions for the processor to implement. The sensor node may further include circuitry for wireless communication with other sensor nodes. Each sensor node may further include a sensory element such as a transducer.

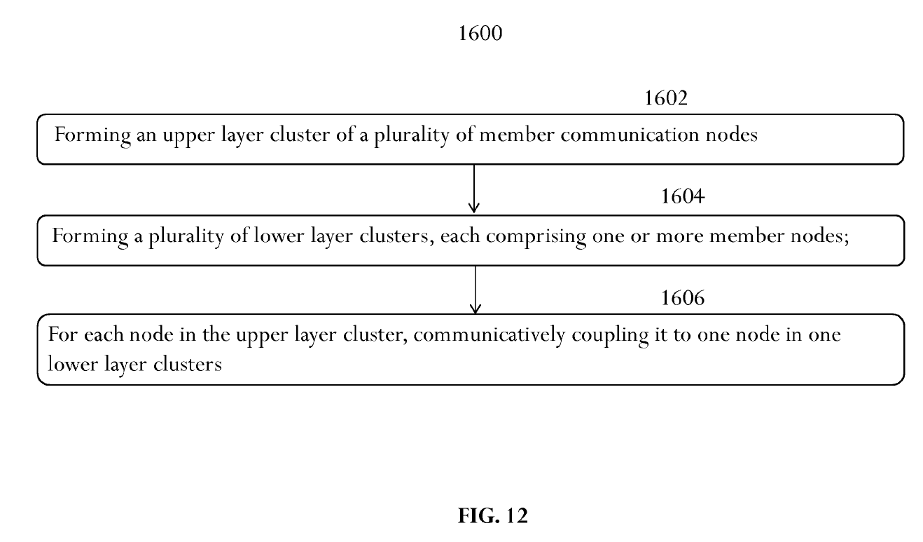

FIG. 12 shows an exemplary method 1600 of forming a hierarchical network. At 1602, an upper layer cluster of a plurality of member communication nodes is formed. The cluster may be formed using the majority consensus protocol described in this document. Alternatively, the cluster formation may be performed using a pre-determined operator setting, a randomized consensus protocol, a raft consensus protocol, a Chandra-Toueg protocol, and so on. At 1604, multiple lower layer clusters are formed. Each of the lower layer cluster may be formed using the consensus protocol as described in the present document or another scheme, e.g., using a pre-programed set of rules, a randomized consensus protocol, a raft consensus protocol, a Chandra-Toueg protocol, and so on.

At 1606, each upper layer cluster node may be communicatively coupled to one node from one of the lower layer clusters. In some embodiments, the upper layer cluster node and the corresponding lower layer cluster node may be one and the same node. Alternatively, these may be two different nodes, which communicate over a wireless communication channel.

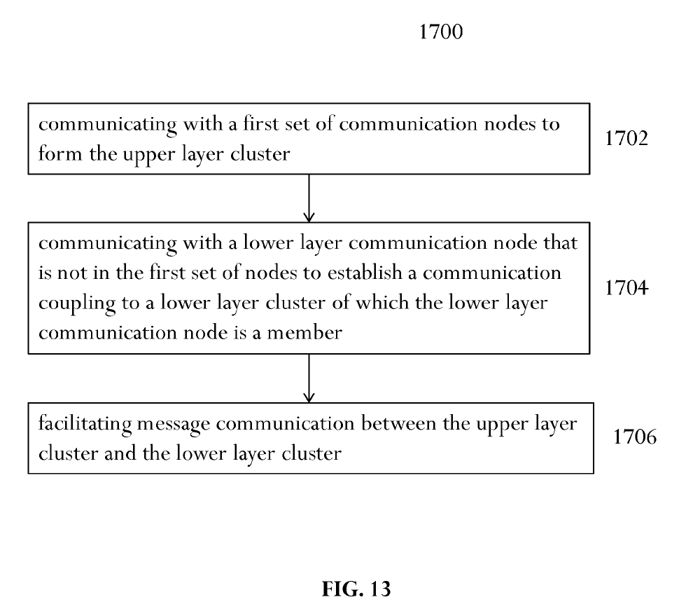

FIG. 13 shows an example method 1700 of operating an upper layer cluster node. The method 1700 includes communicating with a first set of communication nodes to form the upper layer cluster (1702), communicating with a lower layer communication node that is not in the first set of nodes to establish a communication coupling to a lower layer cluster of which the lower layer communication node is a member (1704), and facilitating message communication between the upper layer cluster and the lower layer cluster (1706).

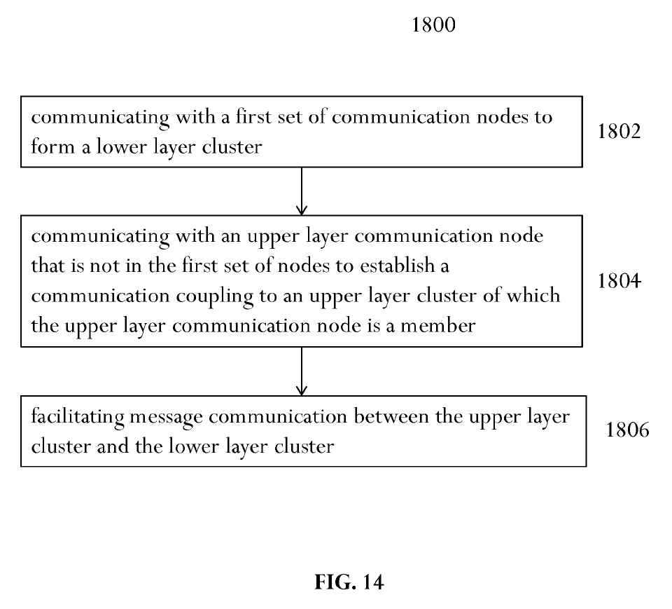

FIG. 14 shows an example method 1800 of operating a lower layer cluster node in a distributed network of multiple sensor nodes in which communication nodes are logically organized in an upper layer cluster and a plurality of lower layer clusters in such that one node from each of the lower layer cluster is communicatively coupled to a different node from the upper layer cluster. The method 1800 includes, communicating with a first set of communication nodes to form a lower layer cluster (1802), communicating with an upper layer communication node that is not in the first set of nodes to establish a communication coupling to an upper layer cluster of which the upper layer communication node is a member (1804), and facilitating message communication between the upper layer cluster and the lower layer cluster (1806).

The methods 1700 and 1800 may use a consensus based method for the formation of the upper layer cluster or the lower layer cluster. In methods 1700 and 1800, the communication between two communication nodes that are members of two different lower layer clusters may happen as follows for node A in lower layer cluster A and node B in lower layer cluster B: Node A in lower layer cluster A may communicate messages with node X in the lower layer cluster, which may in turn communicate with node Y in the upper layer cluster, which may communicate with node Z in the upper layer cluster, which may communicate with node W in the lower layer cluster in which node B lies and node W may communicate with node B.

In some embodiments, one of the upper layer cluster nodes may be designated as a proxy node for communication by all nodes in the distributed network with outside nodes, e.g., application servers for sensor networks. Messages from outside nodes may be received by the proxy node, which then may forward the messages to the upper layer node that is communicatively coupled to a lower layer node from a lower layer cluster to which the intended receiving node of the message belongs to. The message is then forwarded on to the receiving node. Similarly, messages from each lower layer node may traverse through a first “gateway” node that relays the messages from lower layer cluster to the upper layer cluster, and on to the proxy node in the upper layer cluster, which then relays the message to the outside node. In some embodiments, a communication apparatus for operation in a distributed network of multiple communication nodes in which communication nodes are logically organized in an upper layer cluster and a plurality of lower layer clusters in such that one node from each of the lower layer cluster is communicatively coupled to a different node from the upper layer cluster includes a processor and a memory. The memory stores instructions that cause the communication apparatus to implement a method by which the communication apparatus communicates with a first set of communication nodes to form a lower layer cluster; communicates with an upper layer communication node that is not in the first set of nodes to establish a communication coupling to an upper layer cluster of which the upper layer communication node is a member and facilitates a message communication between the upper layer cluster and the lower layer cluster, as described herein. In some embodiments, the communication to form the upper layer cluster includes establishing a consensus among nodes to form the upper layer cluster. In some embodiments, the operation of establishing the communication coupling includes using a timer based control to complete the establishing.

It will be appreciated that various techniques for operating a distributed network of communication nodes have been disclosed. A node may comprises, e.g., a transceiver, a processor and a memory that stores program code used by the processor and data (e.g., signal quality lists) used during operation.

It will also be appreciated that the disclosed techniques can be used to organize a distributed network of communication nodes in a multi-level hierarchy of clusters in which nodes in a lower layer cluster communicate with nodes in an upper layer cluster or other lower layer clusters through a single node that has a cross-cluster communication link. The formation of clusters could be based on operational criteria such as received signal quality, transmission power of the nodes, and so on.

It will further be appreciated that the disclosed techniques can advantageously lead to sensor networks in which communication is performed using clusters, thereby saving resources such as transmission power, transmission bandwidth and so on.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A sensor network, comprising:
a proposer, which is a sensor node capable of gathering and processing sensory information and communicating with other nodes in the sensory network;
a set of proxy acceptors, which are sensor nodes, wherein each node of the set of proxy acceptors and the proposer are communicatively coupled by a first topology;
a set of cluster proposers, which are sensor nodes, wherein each proxy acceptor is communicatively coupled to a corresponding cluster proposer; and
a set of cluster acceptors corresponding to each cluster proposer, wherein each cluster proposer and its set of cluster acceptors are connected by an individual topology.

2. The sensor network system of claim 1, wherein the proposer and the cluster proposer and proxy acceptors have more transmit power than the cluster acceptors.

3. The sensor network system of claim 1, wherein the first topology and the set of individual topologies demonstrate independent expected latency.

4. The sensor network system of claim 1, wherein formation of the first topology and the set of individual topologies is optimized based on transmit power reduction and latency reduction.

5. The sensor network system of claim 1, wherein:
a cluster acceptor is closest to its cluster proposer among any other cluster proposers and the proposer.

6. The sensor network system of claim 1, wherein each cluster proposer has a similar number of cluster acceptors.

7. The sensor network system of claim 1, wherein a sensor node is either pre-programmed to be a proposer at deployment, or randomly chosen to be a proposer.

8. A method performed by a sensor node, comprising:
activating a sensor node, which is capable of gathering and processing sensory information and communicating with other nodes in the network, in a sensor network;
sending a message to other connected sensor nodes indicating a power level of the sensor node;
receiving messages from other connected sensor nodes indicating power levels of other connected sensor nodes; and
determining the sensor node to function as a proposer to form a cluster, initiate a consensus protocol, and reach a consensus, or as an acceptor to be a part of a cluster waiting for a consensus forming protocol message from a proposer.

9. The method of claim 8, wherein determining the sensor node to function as a proposer comprises:
comparing all the received messages from other connected sensor nodes indicating received power levels of other connected sensor nodes.

10. The method of claim 8 further comprising:
listing other sensor nodes according to a quality of received signal.

11. The method of claim 10, further comprising:
initiating a consensus forming protocol; and
reaching a consensus among all the sensor nodes in the sensor network by a democratic decision process.

12. The method of claim 11, further comprising:
reaching a consensus among all the sensor nodes is by a majority vote.

13. A communication network comprising:
an upper layer cluster of a plurality of member communication nodes; and
a plurality of lower layer clusters that is different from the first layer, each comprising one or more member communication nodes;
wherein each node in the upper layer cluster is communicatively coupled with a different node in the plurality of lower layer clusters;
wherein each cluster is formed based upon a pre-determined listing method used by its member nodes; and
wherein a cluster is a logical group of nodes that communicate application layer data with other member nodes of the cluster.

14. The communication network of claim 13 wherein at least some of the communication nodes are also sensor nodes that can sense a physical event.

15. The communication network of claim 13, wherein the predetermined listing method includes monitoring transmit power of nodes.

16. A method of operating a communication node in a distributed network of multiple communication nodes in which communication nodes are logically organized in an upper layer cluster and a plurality of lower layer clusters in such that one node from each of the lower layer cluster is communicatively coupled to a different node from the upper layer cluster, the method implemented at a node in the upper layer cluster, comprising:
communicating with a first set of communication nodes to form the upper layer cluster;
communicating with a lower layer communication node that is not in the first set of nodes to establish a communication coupling to a lower layer cluster of which the lower layer communication node is a member; and
facilitating message communication between the upper layer cluster and the lower layer cluster.

17. The method of claim 16, wherein the communication to form the upper layer cluster includes establishing a consensus among nodes to form the upper layer cluster.

18. The method of claim 17, wherein the establishing the communication coupling includes using a timer based control to complete the establishing.

19. A communication apparatus for operation in a distributed network of multiple communication nodes in which communication nodes are logically organized in an upper layer cluster and a plurality of lower layer clusters in such that one node from each of the lower layer cluster is communicatively coupled to a different node from the upper layer cluster, the apparatus performing a method, comprising:
communicating with a first set of communication nodes to form a lower layer cluster;
communicating with an upper layer communication node that is not in the first set of nodes to establish a communication coupling to an upper layer cluster of which the upper layer communication node is a member; and
facilitating message communication between the upper layer cluster and the lower layer cluster.

20. The apparatus of claim 19, wherein the communication to form the upper layer cluster includes establishing a consensus among nodes to form the upper layer cluster.

21. The apparatus of claim 19, wherein the establishing the communication coupling includes using a timer based control to complete the establishing.

22-23. (canceled)

24. A computer-readable storage medium storing code, when executed by a processor, causing the processor to implement a method, comprising:
activating a sensor node, which is capable of gathering and processing sensory information and communicating with other nodes in the network, in a sensor network;
sending a message to other connected sensor nodes indicating a power level of the sensor node;
receiving messages from other connected sensor nodes indicating power levels of other connected sensor nodes; and
determining the sensor node to function as a proposer to form a cluster, initiate a consensus protocol, and reach a consensus, or as an acceptor to be a part of a cluster waiting for a consensus forming protocol message from a proposer.

25. The computer-readable storage medium of claim 24, wherein determining the sensor node to function as a proposer comprises:
comparing all the received messages from other connected sensor nodes indicating received power levels of other connected sensor nodes.

26. The computer-readable storage medium of claim 24, wherein the method further includes:
listing other sensor nodes according to a quality of received signal.

27. The computer-readable storage medium of claim 26, wherein the method further includes:
initiating a consensus forming protocol; and
reaching a consensus among all the sensor nodes in the sensor network by a democratic decision process.

28. The computer-readable storage medium of claim 27, wherein the method further includes:
reaching a consensus among all the sensor nodes is by a majority vote.

29. A computer-readable storage medium storing code, when executed by a processor, causing the processor to implement a method of operating a communication node in a distributed network of multiple communication nodes in which communication nodes are logically organized in an upper layer cluster and a plurality of lower layer clusters in such that one node from each of the lower layer cluster is communicatively coupled to a different node from the upper layer cluster, the method implemented at a node in the upper layer cluster, the code comprising:
code for communicating with a first set of communication nodes to form the upper layer cluster;
code for communicating with a lower layer communication node that is not in the first set of nodes to establish a communication coupling to a lower layer cluster of which the lower layer communication node is a member; and
code facilitating message communication between the upper layer cluster and the lower layer cluster.

30. The computer-readable storage medium of claim 29, wherein the code for communication to form the upper layer cluster includes code for establishing a consensus among nodes to form the upper layer cluster.

31. The computer-readable storage medium of claim 30, wherein the code for establishing the communication coupling includes code for using a timer based control to complete the establishing.
